(19) United States
(12) Patent Application Publication
(10) Pub. No.: US 2016/0072386 A1
(43) Pub. Date: Mar. 10, 2016

(54) SWITCHING POWER SUPPLY

(71) Applicant: Kabushiki Kaisha Toshiba, Tokyo (JP)

(72) Inventor: Hiroshi Saito, Oota Tokyo (JP)

(21) Appl. No.: 14/604,221

(22) Filed: Jan. 23, 2015

(30) Foreign Application Priority Data
Sep. 10, 2014 (JP) 2014-184505

(51) Int. Cl. H02M 3/158

(52) U.S. Cl. CPC H02M 3/158

(57) ABSTRACT

According to one embodiment, a first transistor is a high-side switching transistor. A second transistor is a low-side switching transistor. A third transistor has one end that is connected the other end of the first transistor and a control terminal that is connected to the ground potential, and is a normally-on type transistor. A diode has a cathode that is connected to the other end of the third transistor and an anode that is connected to the ground potential.

### CROSS REFERENCE TO RELATED APPLICATION

This application is based upon and claims the benefit of priority from the prior Japanese Patent Application No. 2014-184505, filed on Sep. 10, 2014, the entire contents of which are incorporated herein by reference.

### FIELD

Embodiments described herein relate to a switching power supply.

### BACKGROUND

A large number of switching power supplies such as DC-DC converters or AC-DC power supplies, for example, are used for consumer appliances, industrial equipment, and the like. Switching transistors constituting a switching power supply mainly use a silicon power metal oxide semiconductor field effect transistor (MOSFET) or a silicon insulated gate bipolar transistor (IGBT), which cause a large electric power loss.

For this reason, switching power supplies that use an SiC power device or a GaN power device having a less electric power loss than the silicon devices have been developed.

In a case where an SiC MOSFET is used as a low-side switching transistor in a switching power supply, the efficiency of the switching power supply is lowered during an OFF period of the low-side switching transistor.

### BRIEF DESCRIPTION OF THE DRAWINGS

FIG. 1 is a circuit diagram illustrating a switching power supply according to a first embodiment;

FIG. 2 is a circuit diagram illustrating a switching power supply in a comparative example according to the first embodiment;

FIG. 3 a view illustrating characteristics of elements that constitute the switching power supply according to the first embodiment;

FIG. 4 is a timing chart illustrating an operation of the switching power supply according to the first embodiment;

FIG. 5 is a diagram illustrating a flow of current during a period A when a high-side switching transistor turns on, and a low-side switching transistor and a third transistor turn off according to the first embodiment;

FIG. 6 is a diagram illustrating a flow of current during a period B when the high-side switching transistor and the low-side switching transistor turn off, and the third transistor turns on according to the first embodiment;

FIG. 7 is a diagram illustrating a flow of current during a period C when the high-side switching transistor turns off, and the low-side switching transistor and the third transistor turn on according to the first embodiment;

FIG. 8 is a diagram illustrating a flow of current during a period D when the high-side switching transistor and the low-side switching transistor turn off, and the third transistor turns on according to the first embodiment;

FIG. 9 is a timing chart illustrating an operation of the switching power supply in the comparative example according to the first embodiment;

FIG. 10 is a graph illustrating a relation of the electric power efficiency relative to an absolute value of the voltage at a node N1 during a period of a dead time according to the first embodiment;

FIG. 11 is a circuit diagram illustrating a switching power supply according to a second embodiment; and

FIG. 12 is a circuit diagram illustrating a switching power supply according to a third embodiment.

### DETAILED DESCRIPTION

According to one embodiment, a switching power supply includes a first transistor, a second transistor, a third transistor, and a diode. The first transistor has one end into which an input voltage is inputted and a control terminal into which a first control signal is inputted, and operates between ON and OFF states in response to the first control signal. The second transistor has one end that is connected to the other end of the first transistor, a control terminal to which a second control signal is inputted, and the other end that is connected to a ground potential, and operates between ON and OFF states in response to the second control signal. The third transistor has one end that is connected the other end of the first transistor and a control terminal that is connected to the ground potential, and is a normally-on type transistor. The diode has a cathode that is connected to the other end of the third transistor and an anode that is connected to the ground potential.

Hereinafter, a plurality of embodiments will be further described with reference to the drawings. In the drawings, the same reference numerals indicate the same or the similar portions.

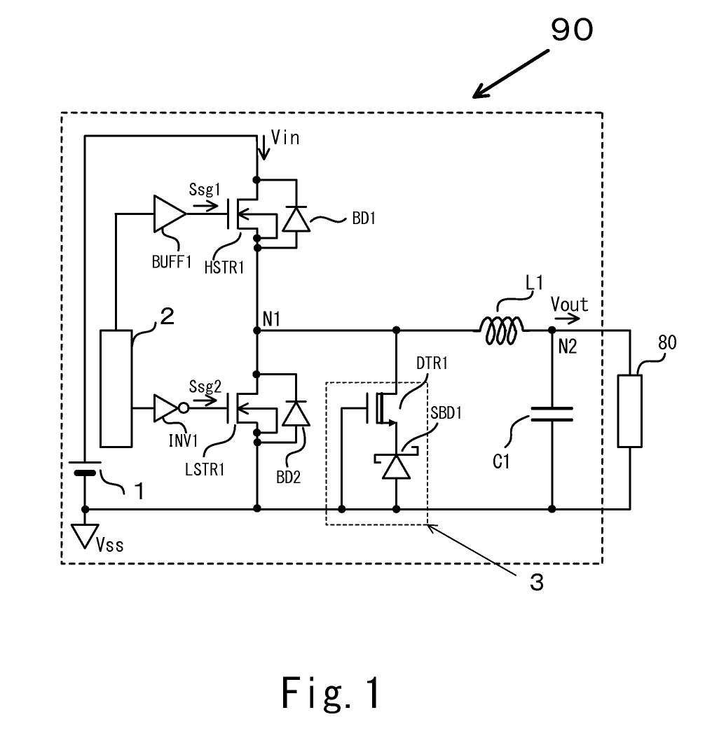

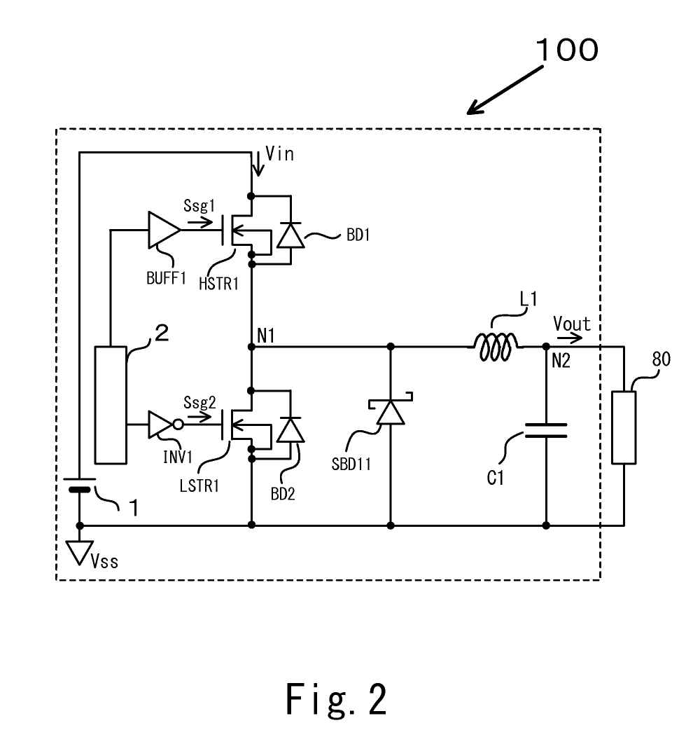

A switching power supply according to a first embodiment will be described with reference to the drawings. FIG. 1 is a circuit diagram illustrating the switching power supply. FIG. 2 is a circuit diagram illustrating a switching power supply in a comparative example. In the embodiment, a serially-connected normally-on type GaN HEMT and a silicon Schottky barrier diode are disposed in parallel with a low-side switching transistor. This configuration prevents reduction in efficiency of the switching power supply during an OFF period of the low-side switching transistor, in other words, during a period of the dead time.

As shown in FIG. 1, a switching power supply 90 includes a power supply 1, a controller 2, a rectification unit 3, a buffer BUFF1, a switching transistor HSTR1, an inverter INV1, a switching transistor LSTR1, an inductor L1, and a smoothing capacitor C1. The switching power supply 90 is used as an in-vehicle use step-down DC-DC converter, for example. The switching power supply is widely applied to fields of electric railroads, inverters, servers, medical devices, various kinds of power supplies, in-vehicle use devices such as EV/HEV, and household electrical appliances such as air-conditioners and others.

The switching power supply 90 steps down an input voltage Vin to supply electric power with high efficiency to a load 80, for example, that is vehicle-mounted electronic equipment.

The power supply 1 generates the input voltage Vin. The controller 2 controls operations of the switching transistor HSTR1 (first transistor) and the switching transistor LSTR1 (second transistor).

The buffer BUFF1 that is provided between the controller 2 and the switching transistor HSTR1 receives input of a signal outputted from the controller 2, and outputs a control signal Ssg1 (first control signal) to a gate (control terminal) of the switching transistor HSTR1.

The inverter INV1 that is provided between the controller 2 and the switching transistor LSTR1 inverts a signal outputted from the controller 2, and outputs a control signal Ssg2 (second control signal) to a gate (control terminal) of the switching transistor LSTR1.

The high-side switching transistor HSTR1 is configured to include a high-breakdown-voltage N-channel SiC MOSFET, and is of a normally-off type (Etype). The switching transistor HSTR1 has one end into which the input voltage Vin is inputted, the other end that is connected to a node N1 and a back gate, and the gate into which the control signal Ssg1 is inputted. The high-side switching transistor HSTR1 operates between ON and OFF states in response to the control signal Ssg1.

A body diode BD1 is a PN diode formed inside the switching transistor HSTR1, and protects the switching transistor HSTR1 against an overvoltage such as a surge. The body diode BD1 has a cathode that is connected to the one end of the switching transistor HSTR1, and an anode that is connected to the other end of the switching transistor HSTR1.

The low-side switching transistor LSTR1 is configured to include a high-breakdown-voltage N-channel SiC MOSFET, and is of a normally-off type (Etype). The switching transistor LSTR1 has one end that is connected the other end (the node N1) of the switching transistor HSTR1, the other end that is connected a back gate and a ground potential Vss, and the gate into which the control signal Ssg2 is inputted. The low-side switching transistor LSTR1 operates between ON and OFF states in response to the control signal Ssg2.

A body diode BD2 is a PN diode formed inside the switching transistor LSTR1, and protects the switching transistor LSTR1 against an overvoltage such as a surge. The body diode BD2 has a cathode that is connected to the one end of the switching transistor LSTR1, and an anode that is connected to the other end of the switching transistor LSTR1.

Note that, the recovery characteristics of the body diode BD1 and the body diode BD2 are slower than the recovery characteristics of an externally mounted diode, for example.

The rectification unit 3 includes a transistor DTR1 and a Schottky barrier diode SBD1. The rectification unit 3 is disposed in parallel with the switching transistor LSTR1.

The transistor DTR1 (third transistor) is a high-breakdown-voltage N-channel GaN high electron mobility transistor (HEMT). The transistor DTR1 is provided on a conductive silicon substrate, for example. The transistor DTR1 is a normally-on type (Dtype) transistor, has a threshold voltage of −2 V. The transistor DTR1 has one end that is connected the node N1 (the one end of the switching transistor LSTR1 and the other end of the switching transistor HSTR1), a gate (control terminal) that is connected to the ground potential Vss, and a floating back gate. The other end of the transistor DTR1 is not connected to the back gate.

The silicon (Si) Schottky barrier diode SBD1 has a cathode that is connected to the node N1 (the one end of the switching transistor LSTR1 and the other end of the switching transistor HSTR1) via the transistor DTR1, and an anode that is connected to the ground potential Vss.

The inductor L1 has one end that is connected to the node N1, and the other end that is connected to a node N2. The smoothing capacitor C1 has one end that is connected to the node N2, and the other end that is connected to the ground potential Vss. The inductor L1 and the smoothing capacitor C1 step down the input voltage Vin, and supply the electric power to the load 80.

A switching power supply 100 in a comparative example includes the power supply 1, the controller 2, the buffer BUFF1, the switching transistor HSTR1, the inverter INV1, the switching transistor LSTR1, a Schottky barrier diode SBD11, the inductor L1, and the smoothing capacitor C1

In the switching power supply 100, the Schottky barrier diode SBD11 is provided instead of the rectification unit 3 of the switching power supply 90 according to the embodiment. Explanations of other portions having the configuration similar to that of the switching power supply 90 according to the embodiment are omitted.

The SiC Schottky barrier diode SBD11 has a cathode that is connected to the node N1 (the one end of the switching transistor LSTR1 and the other end of the switching transistor HSTR1), and an anode that is connected to the ground potential Vss.

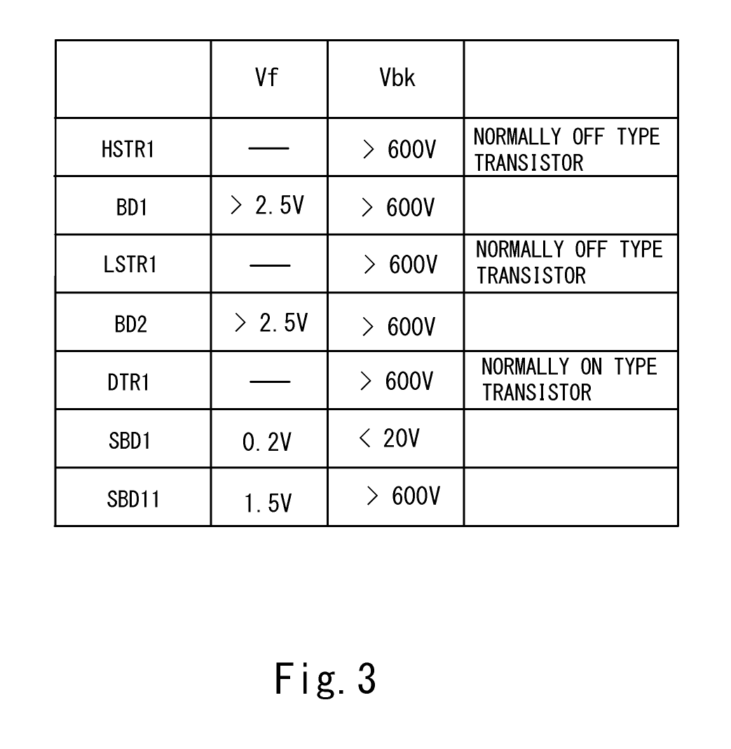

FIG. 3 illustrates characteristics of elements of the switching power supply 90 according to the embodiment and the switching power supply 100 in the comparative example.

Each of the switching transistors HSTR1, the switching transistors LSTR1, and the transistors DTR1 in the embodiment and the comparative example has a breakdown voltage Vbk of 600 V or higher. Such high-breakdown-voltage transistors can handle the surge and the overvoltage required for in-vehicle use.

Each of the body diode BD1 and the body diode BD2 has a breakdown voltage Vbk of 600 V or higher, and a forward voltage Vf of 2.5 V or higher. The forward voltage Vf of the body diode BD1 and the body diode BD2 that are SiC MOSFETs is larger than the forward voltage Vf (0.6 V) of a body diode that is a silicon MOSFET.

The silicon (Si) Schottky barrier diode SBD1 according to the embodiment has a forward voltage Vf of 0.2 V, and a breakdown voltage Vbk smaller than 20 V. In contrast, the SiC Schottky barrier diode SBD11 in the comparative example has a forward voltage Vf (Vf=1.5 V) larger than that of the Schottky barrier diode SBD1, and a breakdown voltage Vbk of 600 V or higher.

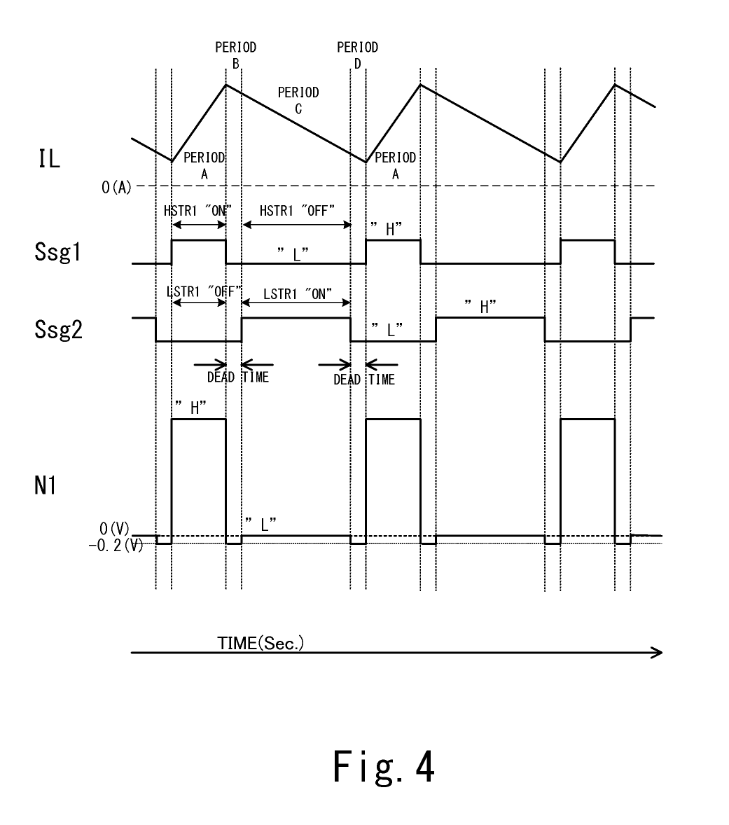

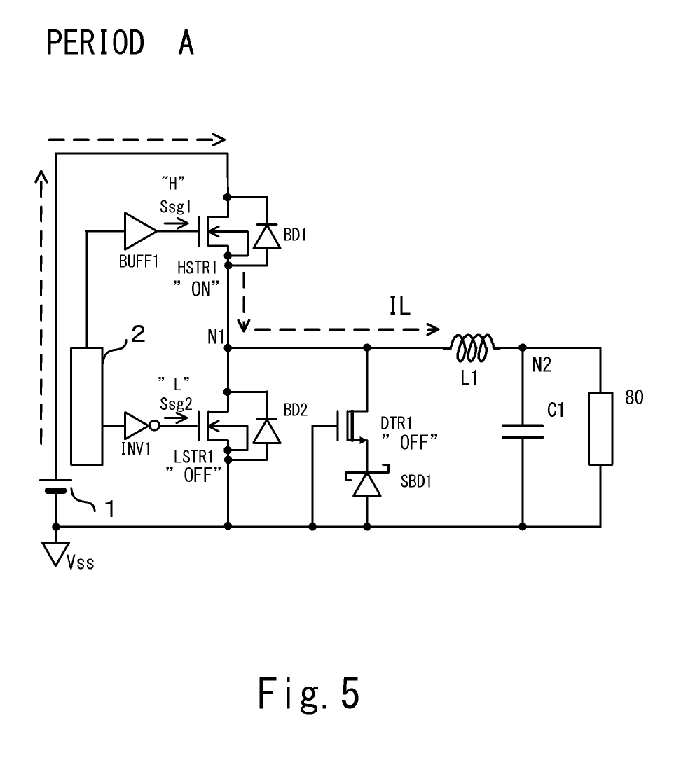

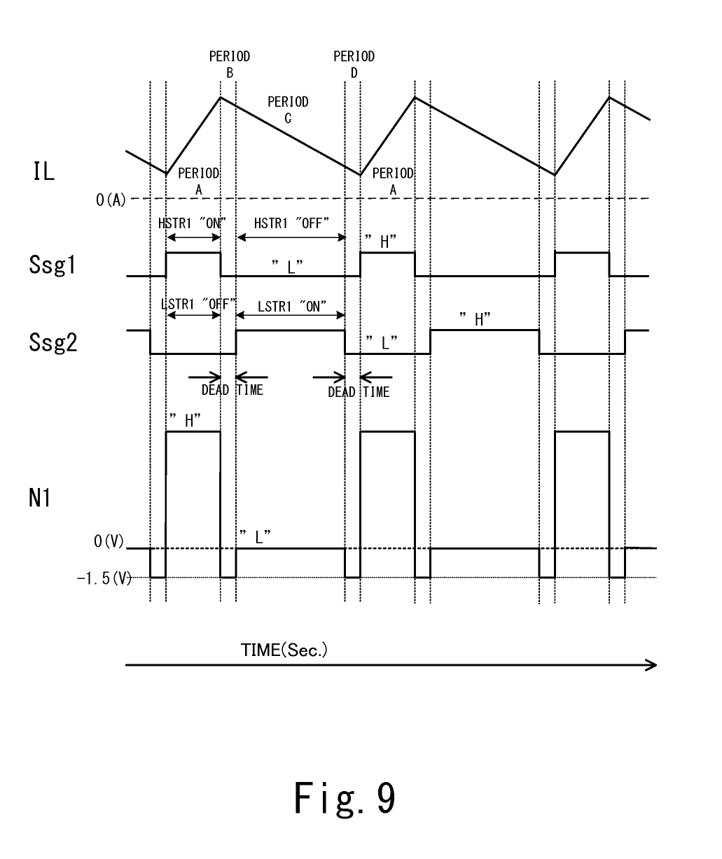

Operations of the switching power supplies are explained in FIG. 4 to FIG. 9. FIG. 4 is a timing chart illustrating the operation of the switching power supply according to the embodiment. FIG. 5 to FIG. 8 illustrate flows of current during periods A to D. FIG. 9 is a timing chart illustrating an operation of the switching power supply in the comparative example.

As shown in FIG. 4 and FIG. 5, during the period A, a High-level (in an enable state) control signal Ssg1 causes the switching transistor HSTR1 to turn on, and a Low-level (in a disable state) control signal Ssg2 causes the switching transistor LSTR1 to turn off. In this process, a voltage is not applied to the Schottky barrier diode SBD1 because the transistor DTR1 turns off. For this reason, the Schottky barrier diode SBD1 having a low breakdown voltage (20 V or less) may not be destroyed. A reverse voltage not more than the breakdown voltage Vbk is applied between the both ends of the body diode BD2, so that no current flows therebetween.

An inductor current IL successively flows from the power supply 1 through the switching transistor HSTR1 to the node N1. The inductor current IL is small at the beginning of the period A but increases as the time elapses. A signal at the node N1 becomes at “High” level.

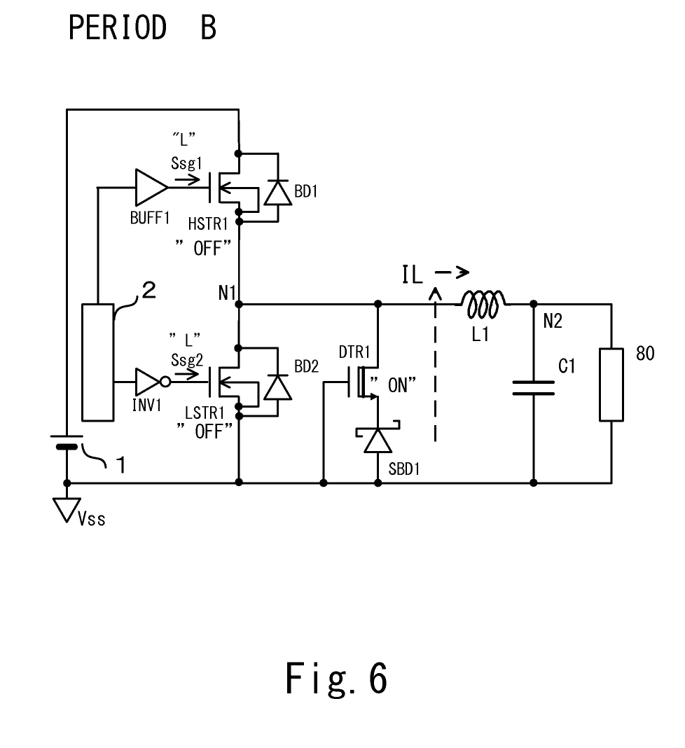

As shown in FIG. 4 and FIG. 6, during the period B, a Low-level (disable state) control signal Ssg1 causes the switching transistor HSTR1 to turn off, and a Low-level (disable state) control signal Ssg2 causes the switching transistor LSTR1 to turn off. When the switching transistor LSTR1 turns off, a regenerative current flows from the node N2 toward the node N1. In this process, the transistor DTR1 turns on, and a forward bias is applied to the Schottky barrier diode SBD1. Note that, the controller 2 sets the period B that is a dead time (DEAD TIME) period.

The inductor current IL successively flows from the ground potential Vss through the Schottky barrier diode SBD1 to the transistor DTR1. The inductor current IL is large at the beginning of the period B but decreases as the time elapses. The signal level at the node N1 becomes −0.2 V reflecting a voltage drop based on the forward voltage Vf of the Schottky barrier diode SBD1.

The electric power loss generated during the period B that is a dead time (DEAD TIME) period is in proportion to an absolute value |V_{N1}| of the signal voltage at the node N1.

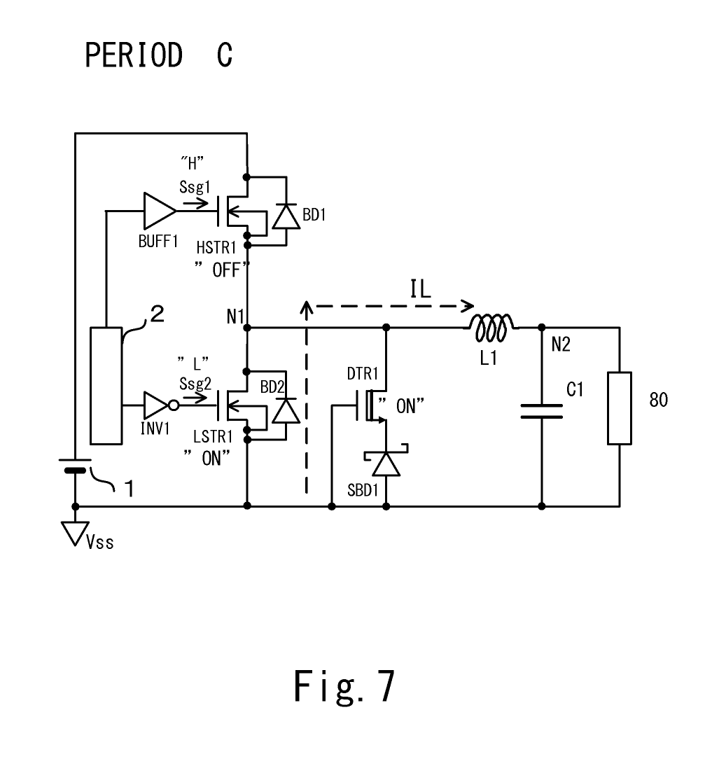

As shown in FIG. 4 and FIG. 7, during the period C, a Low-level (disable state) control signal Ssg1 causes the switching transistor HSTR1 to turn off, and a High-level (enable state) control signal Ssg2 causes the switching transistor LSTR1 to turn on.

The inductor current IL thus flows from the ground potential Vss through the switching transistor LSTR1 to the node N1. Moreover, the transistor DTR1 continuously turns on from the period B, so that a small forward bias based on a voltage drop of the switching transistor LSTR1 is applied to the Schottky barrier diode SBD1. Although a slight current thus flows from the ground potential Vss through the Schottky barrier diode SBD1 to the transistor DTR1, an electric power loss in this process due to the Schottky barrier diode SBD1 is so small that it may be ignored. The inductor current IL is large at the beginning of the period C but linearly decreases as the time elapses.

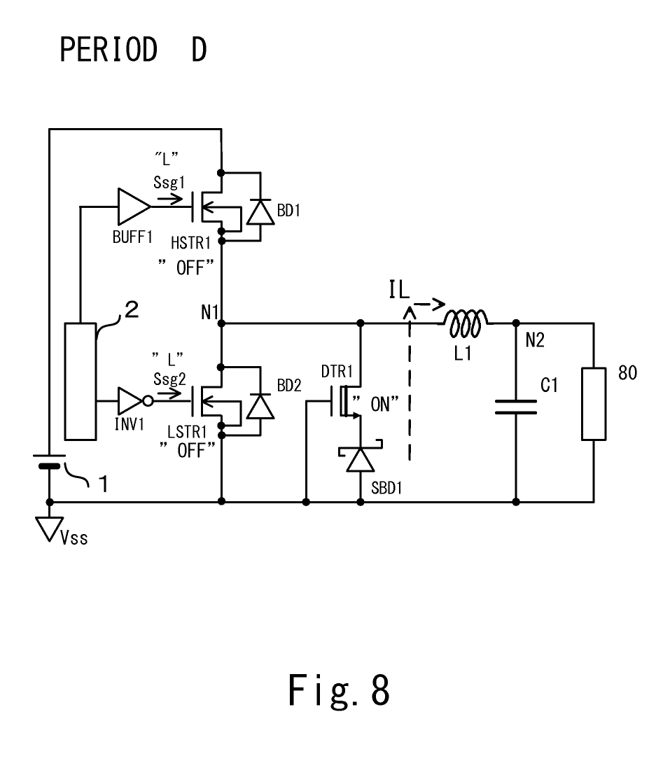

As shown in FIG. 4 and FIG. 8, during the period D, a Low-level (disable state) control signal Ssg1 causes the switching transistor HSTR1 to turn off, and a Low-level (disable state) control signal Ssg2 causes the switching transistor LSTR1 to turn off. When the switching transistor LSTR1 turns off, a regenerative current flows from the node N2 toward the node N1. In this process, the transistor DTR1 turns on, and a forward bias is applied to the Schottky barrier diode SBD1. Moreover, the controller 2 sets the period D that is a dead time (DEAD TIME) period.

The inductor current IL successively flows from the ground potential Vss through the Schottky barrier diode SBD1 to the transistor DTR1. The inductor current IL is large at the beginning of the period D but decreases as the time elapses. The signal level at the node N1 becomes −0.2 V. An absolute value |V_{N1}| of the signal voltage at the node N1 is equivalent to the forward voltage Vf of the Schottky barrier diode SBD1.

An electric power loss generated during the period D that is a dead time (DEAD TIME) period is in proportion to the absolute value |V_{N1}| of the signal voltage at the node N1.

The operations during the periods A to D are repeated in the subsequent processes.

As shown in FIG. 9, the switching power supply 100 in the comparative example performs operations during the periods A to D similar to those by the switching power supply 90 according to the embodiment. However, the switching power supply 100 has a different signal level at the node N1 during the period B and the period D that are dead time (DEAD TIME) periods.

To be specific, during the period B and the period D, a Low-level (disable state) control signal Ssg1 causes the switching transistor HSTR1 to turn off, and a Low-level (disable state) control signal Ssg2 causes the switching transistor LSTR1 to turn off. When the switching transistor LSTR1 turns off, a regenerative current flows from the node N2 toward the node N1. In this process, a forward bias is applied to the Schottky barrier diode SBD11.

For this reason, the signal level at the node N1 becomes −1.5 V. An absolute value |V_{N1}| of the signal voltage at the node N1 is equivalent to the forward voltage Vf of the Schottky barrier diode SBD11.

An electric power loss generated during the period B and the period D that are dead time (DEAD TIME) periods in the comparative example is in proportion to the absolute value |V_{N1}| of the signal voltage at the node N1.

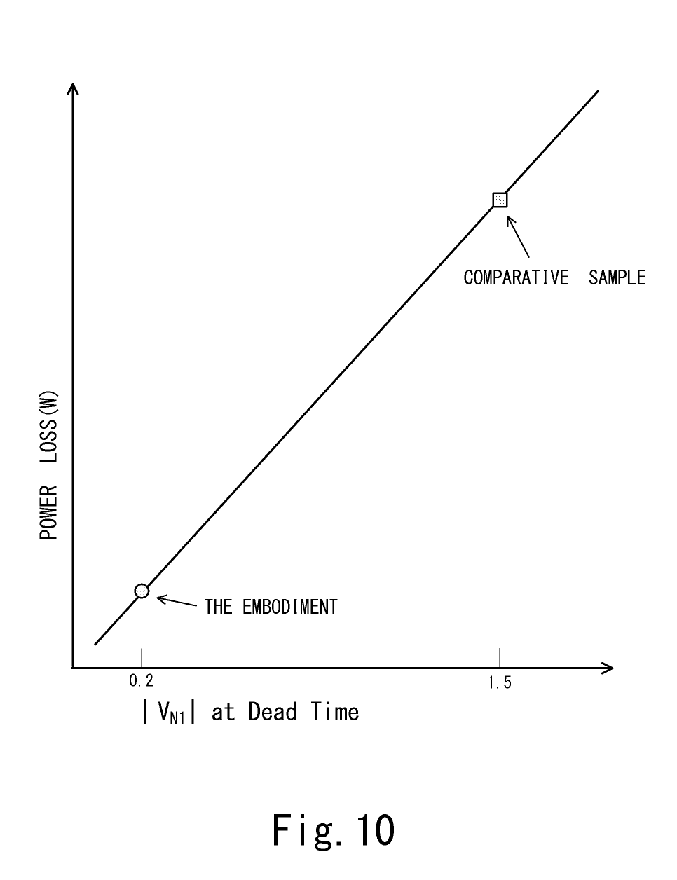

Next, the electric power loss of the switching power supply will be described with reference to FIG. 10. FIG. 10 is a graph illustrating a relation of the electric power efficiency relative to an absolute value of the voltage at the node N1 during the period of the dead time.

As shown in FIG. 10, during the period B and the period D that are dead time (DEAD TIME) periods, the absolute value |V_{N1}| of the signal voltage at the node N1 is set to 0.2 V according to the embodiment, whereas the absolute value |V_{N1}| of the signal voltage at the node N1 is set to 1.5 V in the comparative example.

The electric power loss generated during the dead time (DEAD TIME) period is in proportion to the absolute value |V_{N1}| of the signal voltage at the node N1. Therefore, the electric power loss of the embodiment can be significantly reduced more than that of the comparative example.

As described above, the switching power supply according to the embodiment is provided with the power supply 1, the controller 2, the rectification unit 3, the buffer BUFF1, the switching transistor HSTR1, the inverter INV1, the switching transistor LSTR1, the inductor L1, and the smoothing capacitor C1. The rectification unit 3 is disposed in parallel with the switching transistor LSTR1. The rectification unit 3 is configured to include the transistor DTR1 and the Schottky barrier diode SBD1 that are serially connected to each other. The transistor DTR1 is a normally-on type high-breakdown-voltage N-channel GaN HEMT. The transistor DTR1 has the floating back gate. The Schottky barrier diode SBD1 is a silicon Schottky barrier diode, and the forward voltage Vf is 0.2 V. The absolute value |V_{N1}| of the signal voltage at the node N1 is set to 0.2 V during the period B and the period D that are dead time (DEAD TIME) periods.

Consequently, the electric power loss generated during the dead time (DEAD TIME) periods can be significantly reduced.

The embodiment is applied to the DC-DC converter but is not necessarily limited to the above case. The rectification unit 3 may be disposed in parallel with a low-side switching transistor in a single-phase inverter or a three-phase inverter, for example.

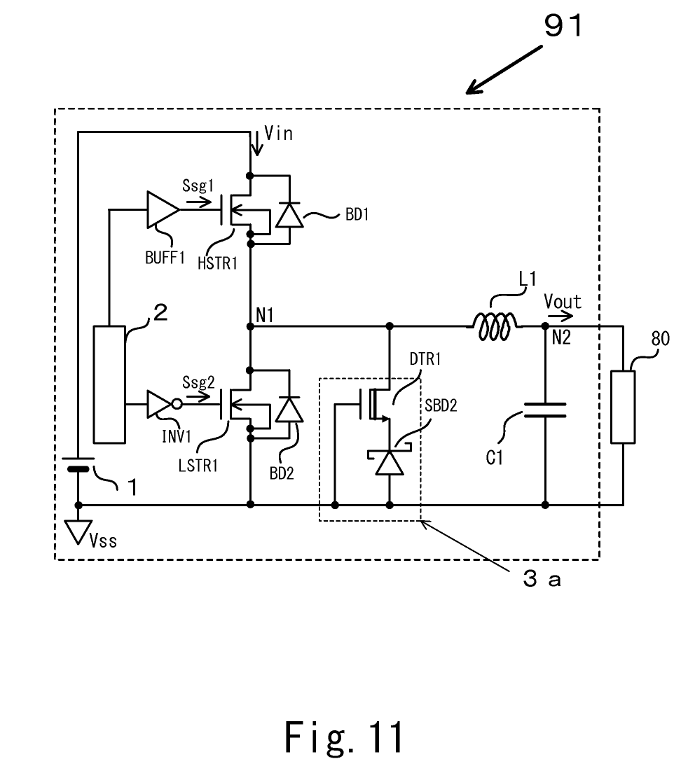

A switching power supply according to a second embodiment will be described with reference to the drawings. FIG. 11 is a circuit diagram illustrating the switching power supply. According to the embodiment, the configuration of the rectification unit is changed.

Hereinafter, the same reference numerals are assigned to the same constitute portions as the first embodiment, explanations thereof are omitted, and only different portions will be described.

As shown in FIG. 11, a switching power supply 91 includes the power supply 1, the controller 2, a rectification unit 3a, the buffer BUFF1, the switching transistor HSTR1, the inverter INV1, the switching transistor LSTR1, the inductor L1, and the smoothing capacitor C1. The switching power supply 91 is used as an in-vehicle use step-down DC-DC converter, for example.

The rectification unit 3a is disposed in parallel with the switching transistor LSTR1. The rectification unit 3a includes the transistor DTR1 and a Schottky barrier diode SBD2 that are serially connected to each other. The Schottky barrier diode SBD2 is a GaN Schottky barrier diode, and has a forward voltage Vf of 0.3 V and a breakdown voltage of 600 V.

The use of the Schottky barrier diode SBD2 allows an absolute value |V_{N1}| of the signal voltage at the node N1 to be set to 0.3 V during the period B and the period D that are dead time (DEAD TIME) periods in the switching power supply 91.

Consequently, similar to the first embodiment, the electric power loss generated during the dead time (DEAD TIME) periods can be significantly reduced.

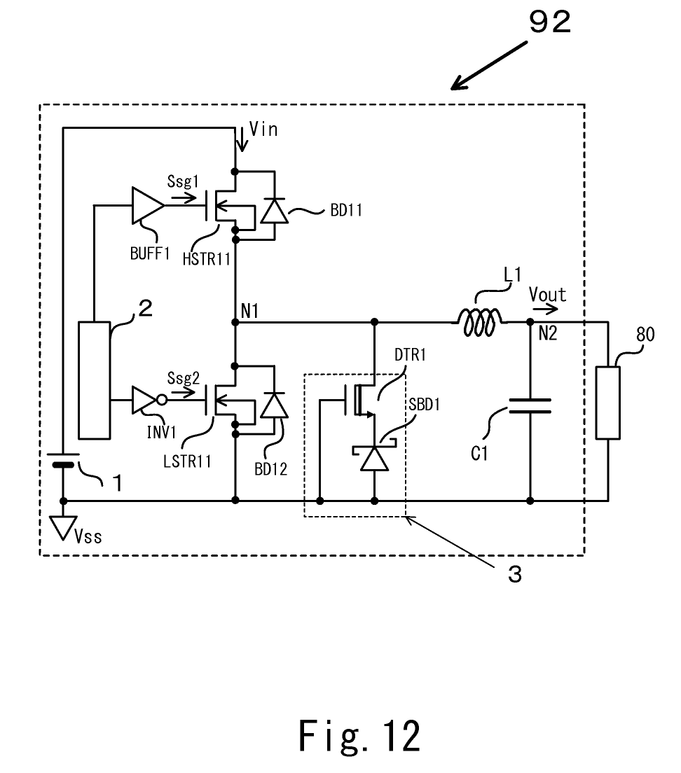

A switching power supply according to a third embodiment will be described with reference to the drawings. FIG. 12 is a circuit diagram illustrating the switching power supply. According to the embodiment, the configurations of a high-side switching transistor and a low-side switching transistor are changed.

Hereinafter, the same reference numerals are assigned to the same constitute portions as the first embodiment, explanations thereof are omitted, and only different portions will be described.

As shown in FIG. 12, a switching power supply 92 includes the power supply 1, the controller 2, the rectification unit 3, the buffer BUFF1, a switching transistor HSTR11, the inverter INV1, a switching transistor LSTR11, the inductor L1, and the smoothing capacitor C1. The switching power supply 92 is used as an in-vehicle use step-down DC-DC converter, for example.

The switching transistor HSTR11 is a high-side switching transistor. The switching transistor HSTR11 is configured to include a high-breakdown-voltage N-channel GaN FET. The switching transistor HSTR11 is of a normally-off type (Etype). The switching transistor HSTR11 has one end into which an input voltage Vin is inputted, the other end that is connected to the node N1, a back gate that is connected to the other end, and a gate into which a control signal Ssg1 is inputted. The switching transistor HSTR11 operates between ON and OFF states in response to the control signal Ssg1.

The switching transistor HSTR11 is provided on a conductive silicon substrate, for example. The switching transistor HSTR11 has a breakdown voltage of 600 V.

A body diode BD11 is a PN diode formed inside the switching transistor HSTR11, and protects the switching transistor HSTR11 against an overvoltage such as a surge. The body diode BD11 has a cathode that is connected to the one end of the switching transistor HSTR11, and an anode that is connected to the other end of the switching transistor HSTR11. The body diode BD11 has a forward voltage Vf of 2.5 V.

The switching transistor LSTR11 is a low-side switching transistor. The switching transistor LSTR11 is configured to include a high-breakdown-voltage N-channel GaN FET. The switching transistor LSTR11 is a normally-off type (Etype) transistor. The switching transistor LSTR11 has one end that is connected to the other end (the node N1) of the switching transistor HSTR11, a back gate that is connected to the other end, the other end that is connected to the ground potential Vss, and a gate into which a control signal Ssg2 is inputted. The switching transistor LSTR11 operates between ON and OFF states in response to the control signal Ssg2.

The switching transistor LSTR11 is provided on a conductive silicon substrate, for example. The switching transistor LSTR11 has a breakdown voltage of 600 V.

A body diode BD12 is a PN diode formed inside the switching transistor LSTR11, and protects the switching transistor LSTR11 against an overvoltage such as a surge. The body diode BD12 has a cathode that is connected to the one end of the switching transistor LSTR11, and an anode that is connected to the other end of the switching transistor LSTR11.

The body diode BD12 has a forward voltage Vf of 2.5 V.

Consequently, similar to the first embodiment, the electric power loss generated during the dead time (DEAD TIME) periods can be significantly reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A switching power supply comprising:
a first transistor including one end into which an input voltage is inputted and a control terminal into which a first control signal is inputted, the first transistor being configured to operate between ON and OFF states in response to the first control signal;
a second transistor including one end connected to the other end of the first transistor, a control terminal into which a second control signal is inputted, and the other end connected to a ground potential, the second transistor being configured to operate between ON and OFF states in response to the second control signal;
a third transistor of a normally-on type including one end connected to the other end of the first transistor and a control terminal connected to the ground potential; and
a diode including a cathode connected to the other end of the third transistor and an anode connected to the ground potential.

2. The switching power supply according to claim 1, wherein a forward voltage of the diode is smaller than a forward voltage of a body diode in the second transistor.

3. The switching power supply according to claim 1, wherein the diode is a Schottky barrier diode.

4. The switching power supply according to claim 3, wherein the Schottky barrier diode is any of a silicon Schottky barrier diode and a GaN Schottky barrier diode.

5. The switching power supply according to claim 1, wherein the third transistor includes a back gate not being connected to the other end of the third transistor.

6. The switching power supply according to claim 1, wherein the third transistor is an N-channel GaN HEMT.

7. The switching power supply according to claim 6, wherein the third transistor is formed on a conductive substrate.

8. The switching power supply according to claim 7, wherein the conductive substrate is a silicon substrate.

9. The switching power supply according to claim 1, wherein the first and second transistors are normally-off type N-channel transistors, and are made of SiC or GaN.

10. The switching power supply according to claim 1, wherein the second control signal is a signal in opposite phase to the first control signal, and a dead time is set to a period during when signal levels of the first and second control signals are shifted.

11. The switching power supply according to claim 10, wherein during the period of the dead time, a potential at the second end of the first transistor becomes lower by the forward voltage of the diode than that of the ground potential.

12. The switching power supply according to claim 1, further comprising:
an inductor including one end connected to the other end of the first transistor; and
a smoothing capacitor including one end connected to the other end of the inductor and the other end connected to the ground potential.

13. The switching power supply according to claim 1, wherein a breakdown voltage of the diode is smaller than breakdown voltages of the first to third transistors.

14. The switching power supply according to claim 1, wherein the breakdown voltages of the first to third transistors are equal to or higher than 600 V.

15. The switching power supply according to claim 1, wherein the switching power supply is a DC-DC converter.

16. The switching power supply according to claim 1, wherein the switching power supply is applied to fields of electric railroads, inverters, servers, medical devices, various kinds of power supplies, in-vehicle use devices such as EV/HEV, and household electrical appliances such as air-conditioners and others.
